(19) United States
(12) Patent Application Publication
(10) Pub. No.: US 2023/0040648 A1
(43) Pub. Date: Feb. 9, 2023

(54) STRING ENTROPY IN A DATA PIPELINE

(71) Applicant: Data Culpa, Inc., Carlisle, MA (US)

(72) Inventor: J. Mitchell Haile, Carlisle, MA (US)

(21) Appl. No.: 17/875,134

(22) Filed: Jul. 27, 2022

Related U.S. Application Data
(60) Provisional application No. 63/228,738, filed on Aug. 3, 2021.

(51) Int. Cl. G06F 16/35

(52) U.S. Cl. CPC G06F 16/355; G06F 16/358

(57) ABSTRACT

Various embodiments comprise systems and methods to determine entropy in strings generated by a data pipeline. In some examples, data monitoring circuitry monitors a data pipeline that ingests input data, processes the input data, and responsively generates and transfers a data string that comprises character groups. The data monitoring circuitry receives the data string, identifies character groups in the data string, identifies group types for the character groups, and assigns numbers to the character groups based on the group types. The data monitoring circuitry determines a probability distribution for the numbers, calculates entropy for the data string based on probability distribution, and generates an entropy histogram based on the entropy. The data monitoring circuitry compares the entropy histogram of the data string to another entropy histogram for another data string, determines a change in entropy, and reports the change in entropy.

### RELATED APPLICATIONS

This U.S. Pat. Application claims priority to U.S. Provisional Pat. Application 63/228,738 entitled “STRING ENTROPY IN A DATA PIPELINE” which was filed on August 3^{rd}, 2021, and which is incorporated by reference into this U.S. Pat. Application in its entirety.

### TECHNICAL BACKGROUND

A data pipeline comprises a series of data processing elements that intake data from a data source, process the input data for a desired effect, and transfer the processed data to a data target. Data pipelines are configured to intake data that comprises a known format for their data processing elements to operate accurately. When the input data to a data pipeline is altered, the data processing elements may not recognize the changes which can cause malfunctions in the operation of the data pipeline. Changes to input data often arise when the data sets are large which results in variety of technical issues exist when processing or ingesting data received through a data pipeline. Implicit schema and schema creep like typos or changes to schema often cause issues when ingesting data. Completeness issues can also arise when ingesting data. For example, completeness can be compromised when there is an incorrect count of data rows/documents, there are missing fields or missing values, and/or there are duplicate and near-duplicate data entries. Additionally, accuracy issues may arise when there are incorrect types in fields. For example, a string field that often comprises numbers is altered to now comprise words. Accuracy issues may further arise when there are incorrect category field values and incorrect continuous field values. For example, a continuous field may usually have distribution between 0 and 100, but the distribution is significantly different on updated rows or out of our usual bounds. Data pipelines may have bugs which impact data quality and data pipeline code is difficult to debug.

These problems associated with data pipelines can cause an increase in information entropy in output data generated by the data pipelines. Information entropy described with relation to an output data set of a data pipeline is a measure of how unpredictable the output data set is. For example, a data set may comprise a series of values that form a data string. When the values of the string comprise few value types, the uncertainty in the type of a given value is low and the information entropy of the string is correspondingly low. In contrast, when the value types of the string increase, the uncertainty in the type of a given value increases and the information entropy of the string correspondingly increases.

Data pipeline monitoring systems are employed to counteract the range of technical issues that occur with data pipelines. Traditional data pipeline monitoring systems employ a user defined ruleset that governs what inputs and outputs for a data pipeline should look like. For example, the manually defined rulesets may indicate schemas, types, value ranges, and data volumes the inputs and outputs of data pipelines should have. The data monitoring systems ingest the inputs and outputs of a data pipeline and apply the manually defined rulesets to the inputs and outputs. When the inputs or outputs deviate from the manually defined rulesets, the data pipeline monitoring systems generate and transfer alerts to notify pipeline operators that a problem has occurred. Unfortunately, the data pipeline monitoring systems do not effectively and efficiently calculate information entropy of the output data of the data pipelines. Moreover, the data pipeline monitoring systems do not effectively and efficiently track changes in information entropy over time.

### OVERVIEW

This Overview is provided to introduce a selection of concepts in a simplified form that are further described below in the Detail Description. This summary is not intended to identify key features or essential features of the claimed subject matter, nor is it intended to be used as an aid in determining the scope of the claimed subject matter.

Various embodiments of the present technology generally relate to solutions for maintaining data integrity. Some embodiments comprise a data pipeline monitoring system to determine data entropy in strings generated by a data pipeline. In the data pipeline monitoring system, data monitoring circuitry monitors the data pipeline. The data pipeline ingests an input data set, processes the input data set, responsively generates a data string that comprises character groups, and transfers the data string to the data monitoring circuitry. The data monitoring circuitry receives the data string and identifies character groups in the data string. The data monitoring circuitry identifies group types for the character groups and numerically represents the character groups based on the group types. The data monitoring circuitry determines a probability distribution for the numeric representations and calculates entropy for the data string based on probability distribution. The data monitoring circuitry generates an entropy histogram based on the entropy. The data monitoring circuitry compares the entropy histogram of the data string to another entropy histogram for another data string and determines a change in entropy between the histogram and the other histogram. The data monitoring circuitry reports the change in entropy.

Some embodiments comprise a method of operating a data pipeline monitoring system to determine data entropy in strings generated by a data pipeline. The method includes data monitoring circuitry monitoring a data pipeline that ingests an input data set, processes the input data set, responsively generates a data string that comprises character groups, and transfers the data string to the data monitoring circuitry. The method continues with the data monitoring circuitry receiving the data string and identifying character groups in the data string. The method continues with the data monitoring circuitry identifying group types for the character groups and numerically representing the character groups based on the group types. The method continues with the data monitoring circuitry determining a probability distribution for the numeric representations and calculating entropy for the data string based on probability distribution. The method continues with the data monitoring circuitry generating an entropy histogram based on the entropy. The method continues with the data monitoring circuitry comparing the entropy histogram of the data string to another entropy histogram for another data string and determining a change in entropy between the histogram and the other histogram. The method continues with the data monitoring circuitry reporting the change in entropy.

Some embodiments comprise a non-transitory computer-readable medium storing instructions to determine data entropy in strings generated by a data pipeline. The instructions, in response to execution by one or more processors, cause the one or more processors to drive a system to perform pipeline monitoring operations. The operations comprise monitoring the data pipeline wherein the data pipeline ingests an input data set, processes the input data set, responsively generates a data string that comprises character groups, and transfers the data string. The operations further comprise receiving the data string. The operations further comprise identifying character groups in the data string. The operations further comprise identifying group types for the character groups. The operations further comprise numerically representing to the character groups based on the group types. The operations further comprise determining a probability distribution for the numeric representations. The operations further comprise calculating entropy for the data string based on probability distribution. The operations further comprise generating an entropy histogram based on the entropy. The operations further comprise comparing the entropy histogram of the data string to another entropy histogram for another data string. The operations further comprise determining a change in entropy between the histogram and the other histogram. The operations further comprise reporting the change in entropy.

### DESCRIPTION OF THE DRAWINGS

Many aspects of the disclosure can be better understood with reference to the following drawings. The components in the drawings are not necessarily drawn to sale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an exemplary data processing environment to determine string entropy.

FIG. 2 illustrates an exemplary operation to determine string entropy.

FIG. 3 illustrates an exemplary operation to determine string entropy.

FIG. 4 illustrates an exemplary histogram to determine string entropy.

FIG. 5 illustrates an exemplary data processing environment to determine string entropy.

FIG. 6 illustrates an exemplary operation to determine string entropy.

FIG. 7 illustrates an exemplary user interface to determine string entropy.

FIG. 8 illustrates an exemplary computing device that may be used in accordance with some embodiments of the present technology.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Various embodiments of the present technology relate to solutions for monitoring the operations of data pipeline systems. More specifically, embodiments of the present technology relate to systems and methods for maintaining consistency between outputs of a data pipeline to detect problems in the data pipeline. Now referring to the Figures.

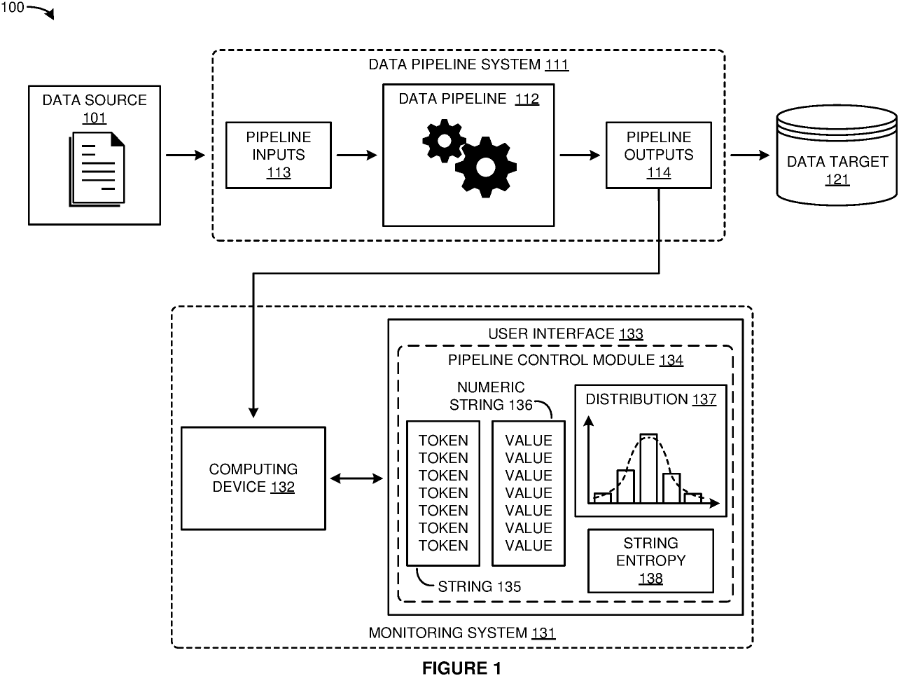

FIG. 1 illustrates data processing environment 100 to monitor operations of a data pipeline. Data processing environment 100 processes raw data generated by data sources into a processed form for use in data analytics, data storage, data harvesting, and the like. Data processing environment 100 comprises data source 101, data pipeline system 111, data target 121, and monitoring system 131. Data pipeline system 111 comprises data pipeline 112, pipeline inputs 113, and pipeline outputs 114. Monitoring system 131 comprises computing device 132, user interface 133, and pipeline control module 134. In other examples, data processing environment 100 may include fewer or additional components than those illustrated in FIG. 1. Likewise, the illustrated components of data processing environment 100 may include fewer or additional components, assets, or connections than shown. Each of data source 101, data pipeline system 111, data target 121, and/or monitoring system 131 may be representative of a single computing apparatus or multiple computing apparatuses.

Data source 101 is operatively coupled to data pipeline system 111. Data source 101 is representative one or more systems, apparatuses, computing devices, and the like that generate raw data for consumption by data pipeline system 111. Data source 101 may comprise a computing device of an industrial system, a financial system, research system, or some other type of system configured to generate data that characterizes that system. For example, data source 101 may comprise a computer affiliated with an online transaction service that generates sales data which characterizes events performed by the online transaction service. It should be appreciated that the type of data generated by data source 101 is not limited.

Data pipeline system 111 is operatively coupled to data pipeline source 101, data target 121, and monitoring system 131. Data pipeline system 111 is representative of a data processing system which intakes “raw” or otherwise unprocessed data from data source 101 and emits processed data configured for consumption by an end user. Data pipeline system 111 comprises data pipeline 112, pipeline inputs 113, and pipeline outputs 114. Pipeline inputs 113 comprise unprocessed data strings generated by data source 101. A data string is a data form that comprises a series of characters groups referred to as tokens. The tokens may comprise words, phrases, repeated letters, letter patterns, acronyms, symbols, alpha-numeric character groups, and/or numbers. Pipeline outputs 114 comprise processed data strings generated by the one or more data processing operations implemented by data pipeline 112. Data pipeline 112 comprises one or more computing devices that are connected in series that intake pipeline inputs 113 received from data source 101 and generate pipeline outputs 114. For example, the computing devices of data pipeline 112 may ingest pipeline inputs 113 and execute transform functions on pipeline inputs 113. The execution of the transform functions alters pipeline inputs 113 into a consumable form to generate pipeline outputs 114. For example, pipeline inputs 113 may comprise strings of non-uniform length and data pipeline 112 may parse the strings to form pipeline outputs 114. Upon generation of pipeline outputs 114, data pipeline 112 transfers pipeline outputs to data target 121. In some examples, data pipeline system 112 may transfer pipeline outputs 114 to computing device 132 to facilitate the monitoring operations of monitoring system 131.

Data target 121 is operatively coupled to data pipeline system 111. Data target 121 is representative of one or more computing systems comprising memory that receive pipeline outputs 114 generated by data pipeline 112. Data target 121 may comprise a database, data structure, data repository, data lake, another data pipeline, and/or some other type of data storage system. In some examples, data target 121 may transfer pipeline outputs 114 received from data pipeline system 111 to monitoring system 131 to facilitate the pipeline monitoring operations of monitoring system 131.

Monitoring system 131 is operatively coupled to data pipeline system 111. Monitoring system 131 is representative of one or more computing devices configured to monitor the operation of data pipeline system 111. Monitoring system 131 is configured to ingest pipeline outputs 114 from data pipeline 112. Alternatively, monitoring system 131 may possess a communication link with data target 121 and receive pipeline outputs 114 indirectly from data target 121. Monitoring system 131 comprises computing device 132, user interface 133, and pipeline control module 134. Computing device 132 comprises one or more computing apparatuses configured to host pipeline control module 134 and present a Guided User Interface (GUI) on user interface 133. Pipeline control module 134 is representative of one or more applications configured to monitor the operation of data pipeline system 111. It should be appreciated that the specific number of applications and modules hosted by computing device 132 is not limited. Exemplary applications hosted by computing device 132 to monitor the operations of data pipeline system 111 include Data Culpa Validator and the like. Computing device 132 is coupled to user interface 133. User interface 133 comprises a display, keyboard, touchscreen, tablet, and/or other elements configured to provide a visual representation of, and means to interact with, pipeline control module 134. For example, user interface 133 may receive keyboard inputs, touchscreen inputs, and the like to facilitate interaction between a user and pipeline control module 134. User interface 133 provides a GUI display that allows a user to interact with pipeline control module 134 and/or any other application(s) hosted by computing device 102 to monitor the operation of data pipeline system 111.

Pipeline control module 134 comprises visual elements to determine and visualize string entropy in pipeline outputs 114 and to monitor the operations of data pipeline 112. The visual elements include string 135, numeric string 136, distribution 137, and string entropy 138. String 135 comprises a set of tokens. The tokens may comprise groups of letters, words, acronyms, alpha-numeric groups, numbers, and the like. Numeric string 136 is a numeric representation of string 135 and comprises a set of values. The values comprise one or more numbers that correspond to tokens that comprise string 135. For example, one or the tokens of string 135 may comprise the work “purchase” and a corresponding value of numeric string 136 may comprise the number one. In doing, pipeline control module 134 may reduce the number of characters needed to represent pipeline outputs 114. Distribution 137 comprises a probability distribution for the values that comprise numeric string 136. The probability distribution indicates the probability of that a random variable will comprise a value of numeric string 136. The probability distribution may comprise a normal distribution, geometric distribution, uniform distribution, or some other type of probability distribution. Typically, the probability distribution of distribution 137 depends on the values that comprise numeric string 136. String entropy 138 comprises the information entropy of string 135. Pipeline control module 134 may utilize distribution 137 to calculate the information entropy of string 135. In some example, pipeline control module 134 compares information entropy for different strings generated by data pipeline 112 to track how information entropy changes over time.

Data pipeline system 111, data target 121, and monitoring system 131 comprise microprocessors, software, memories, transceivers, bus circuitry, and the like. The microprocessors comprise Central Processing Units (CPUs), Graphical Processing Units (GPUs), Application-Specific Integrated Circuits (ASICs), Field Programmable Gate Arrays (FPGAs), and/or other types of processing circuitry. The memories comprise Random Access Memory (RAM), flash circuitry, disk drives, and/or the like. The memories store software like operating systems, user applications, data analysis applications, and data processing functions. The microprocessors retrieve the software from the memories and execute the software to drive the operation of the data processing system as described herein. The communication links that connect the elements of data processing system use metallic links, glass fibers, radio channels, or some other communication media. The communication links use Time Division Multiplex (TDM), Data Over Cable System Interface Specification (DOCSIS), Internet Protocol (IP), General Packet Radio Service Transfer Protocol (GTP), Institute of Electrical and Electron Engineers (IEEE) 802.11 (WIFI), IEEE 802.3 (ENET), virtual switching, inter-processor communication, bus interfaces, and/or some other data communication protocols. Data pipeline system 111, data target 121, and monitoring system 131 may exist as a single computing device or may be distributed between multiple computing devices.

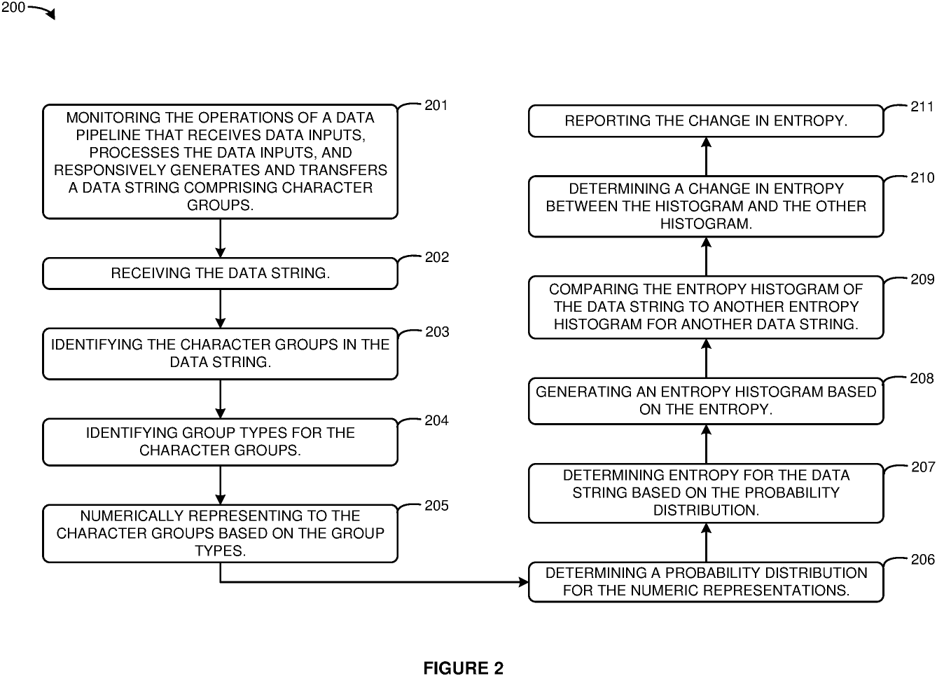

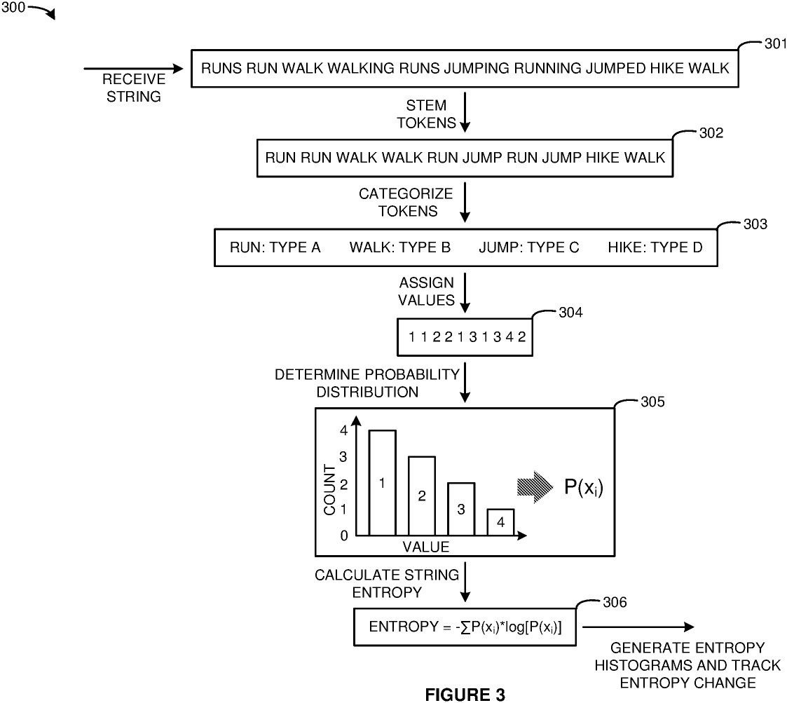

In some examples, data processing environment 100 implements process 200 illustrated in FIG. 2. In some examples, data processing environment 100 implements process 300 illustrated in FIG. 3. It should be appreciated that the structure and operation of data processing environment 100 may differ in other examples.

FIG. 2 illustrates process 200. Process 200 comprises a process to calculate and track string entropy in data pipeline outputs. Process 200 may be implemented in program instructions in the context of any of the software applications, module components, or other such elements of one or more computing devices. The program instructions direct the computing devices(s) to operate as follows, referred to in the singular for the sake of clarity.

The operations of process 200 include monitoring the operations of a data pipeline that receives data inputs, processes the data inputs, and responsively generates and transfers a data string comprising character groups (step 201). The operations continue with receiving the output data string (step 202). The operations continue with identifying the character groups in the data string (step 203). The operations continue with identifying group types for the character groups (step 204). The operations continue with numerically representing the character groups based on the group types (step 205). The operations continues with determining a probability distribution for the numerical representations (step 206). The operations continue with determining entropy for the data string based on the probability distribution (step 207). The operations continue with generating an entropy histogram based on the entropy (step 208). The operations continue with comparing the entropy histogram of the data string to another entropy histogram for another data string (step 209). The operations continue with determining a change in entropy between the histogram and the other histogram (step 210). The operations continue with reporting the change in entropy (step 211).

Referring back to FIG. 1, data processing environment 100 includes a brief example of process 200 as employed by one or more applications hosted by computing device 132, data target 121, and data pipeline 112. The operation may differ in other examples.

In operation monitoring system 131 monitors the operation of the data pipeline (step 201). For example, computing device 132 may be operatively coupled to data pipeline 112. Pipeline control module 134 hosted on computing device 132 may track various attributes (e.g., data schema) of the inputs and outputs of data pipeline 112 to identify problems that occur in data pipeline 112. Data pipeline 112 receives pipeline inputs 113 from data source 101. For example, data pipeline 112 may receive a set of strings that comprise production data from an industrial data source. Data pipeline 112 executes a transform function on pipeline inputs 113 and responsively generates pipeline outputs 114 which comprise a data string. The tokens of the data string comprise character groups. The character groups comprise words, phrases, repeated letters, letter patterns, acronyms, and the like. Data pipeline 112 transfers the data string to computing device 132. For example, data pipeline 112 may call an Application Programming Interface (API) hosted by computing device 132 to ingest the string.

Pipeline control module 134 hosted by computing device 132 receives the data string from data pipeline 112 (step 202). Pipeline control module 134 identifies each of the character groups in the data string and stems the character groups to remove affixes (step 203). For example, pipeline control module 134 may identify a character group that comprises the word “WALKING” and stem the charter group so that it comprises the word “WALK”. Typically, pipeline control module 134 stems the character groups to remove prefixes, suffixes, gerunds, plurals, and the like to simplify and uniformize the character groups. Pipeline control module 134 identifies a group type for each the character groups (step 204) and numerically represents each group type (step 205). For example, pipeline control module 134 may identify a first set of character groups that comprise the word “RUN” and a second set of character groups that comprise the word “SPEED” and numerically represent the first set of the character groups with the number one and numerically represent the second set of the character groups with the number two. In some examples, pipeline control module 134 assign a character group for different tokens that have a similar grammatical meaning. For example, pipeline control module 134 may identify a first set of character groups that comprise the word “SPEED” and a second set of character groups that comprise the word “VELOCITY” and numerically represent both sets of character groups with the number one based on their similar grammatical meaning.

In some examples, pipeline control module 134 determines duplicate character groups in the data string. Pipeline control module 134 determines the number of duplicates and assigns a number for the set of duplicate character groups. For example, pipeline control module may identify 500 tokens in a data string that comprise the word “FAST” and assign a single integer to represent the 500 tokens as a group. In some examples, pipeline control module 134 forgoes the identification of character groups and instead calculates entropy for the string as a whole. For example, the tokens of the string may comprise a list of numbers and pipeline control module 134 may determine a probability distribution for the numbers and calculate entropy for the probability distribution without assigning character groups for the numbers.

Pipeline control module 134 generates a string of numbers (e.g., numeric string 136) that represent the data string (e.g., string 135). Each number represents a character group in the data string. Pipeline control module 134 determines probability distribution 137 based on the numbers (step 206). The probability distribution may comprise a normal distribution, uniform distribution, geometric distribution, or some other type of distribution. Pipeline control module 134 circuitry determines the entropy for the data string based on the probability distribution (step 207). For example, the pipeline control module 134 may execute an entropy function that calculates the entropy of the probability distribution. Pipeline control module 134 normalizes the entropy generates a histogram based on the normalized entropy (step 208).

Data pipeline 112 receives additional data. Data pipeline 112 generates and transfers additional data strings to pipeline control module 134 hosted by computing device 132. Pipeline control module 134 repeats the above process and generates additional entropy histograms for the additional data strings. Pipeline control module 134 circuitry compares the histogram of the data string to the additional histograms of additional data strings (step 209). For example, the pipeline control module 134 may overlay the histograms to determine the change in entropy between the strings. Pipeline control module 134 determines a change in entropy between the histogram and the additional histograms (step 210). Pipeline control module 134 reports the change in entropy to downstream systems (step 211).

Advantageously, the data monitoring system 131 efficiently determines entropy in strings generated by data pipeline 112. Moreover, data monitoring system 131 effectively tracks changes in entropy in the strings generated by data pipeline 112.

FIG. 3 illustrates process 300. Process 300 is an example of process 200 however process 200 may differ. Process 300 comprises a process to determine information entropy in data strings and track changes in entropy over time. Process 300 may be implemented in program instructions in the context of any of the software applications, module components, or other such elements of one or more computing devices (e.g., computing device 132). The program instructions direct the computing devices(s) to operate as follows, referred to in the singular for the sake of clarity. Process 300 may differ in other examples.

In operation, a computing device of a data pipeline monitoring system receives a data string (step 301). The data string comprises a set of tokens. The tokens comprise an ordered list of the words RUNS, RUN, WALK, WALKING, RUNS, JUMPING, RUNNING, JUMPED, HIKE, and WALK. The computing device stems the tokens to remove affixes from the tokens to uniformize similar tokens (step 302). In this example, computing devices stems the tokens to generate the stemmed data string comprising an ordered list of the words RUN, RUN, WALK, WALK, RUN, JUMP, RUN, JUMP, HIKE, and WALK. The computing device determines character group types for the stemmed tokens to categorize the tokens (step 303). The computing device categorizes tokens of the word RUN as type A, tokens of the word WALK as type B, tokens of the word JUMP as type C, and tokens of the word HIKE as type D. The computing device generates a numeric string to numerically represent the unstemmed data string (step 304). The number string comprises the sequence 1, 1, 2, 2, 1, 3, 1, 3, 4, and 2. The number one corresponds to the type A token of RUN. The number two correspond to the type B token of WALK. The number three corresponds to the type C token of JUMP. The number four corresponds to the type D token of HIKE.

By numerically representing the unstemmed string, the computing device may represent the original unstemmed string received from a data pipeline using a fewer number of characters thereby reducing the required computing power and memory space to process the string. The reduction in required computing power and memory space improves the operation of the computing device. The computing device determines a probability distribution for the number sequence of the numeric string (step 305). To calculate the probability distribution, the computing device determines the probability a discreet random variable will comprise a given numbers of the numeric string. In this example, a plot is illustrated that shows the counts for each of the integers in the numeric string. Number one appears four times in numeric string, number two appears three times in the numeric string, number three appears twice in the numeric string, and number four appears once in the numeric string. The computing device constructs a probability distribution that indicates the discreet random variable has a 4/10 probability to comprise the number one, a 3/10 probability to comprise the number two, and a 2/10 probability to comprise the number three, and 1/10 probability to comprise the number four.

Although the string illustrated in FIG. 3 comprises three token types, in other examples the strings may comprise many more tokens as well as token types and their probability distributions correspondingly increase in complexity. It should be appreciated that the illustrated string and distribution are exemplary and that the type of string, size of strings, and the probability distributions are not limited. Returning to the operation, the computing device calculates information entropy for the data string based on the probability distribution (step 306). The information entropy describes the average level of uncertainty in the values that comprise the string. Generally, the information entropy of a string increases when the number of tokens increases, and when the probability distribution of the tokens tends towards uniformity. For example, a string with only one type of token would have a string entropy equal to zero while a string with multiple types of tokens would have a string entropy larger than zero. Moreover, a string whose constituent tokens are distributed geometrically would have a lower information entropy than a string whose tokens are distributed uniformly. The computing device may execute an entropy function on the probability distribution to calculate the information entropy of the string. For example, the entropy function make take the following form:

$$H \left(X\right) = {Σ}_{i = 1}^{n} P \left({x}_{i}\right) {log}_{b} \left[P \left({x}_{i}\right)\right]$$

where H(X) is the information entropy of a discreet random variable X, P(xᵢ) is the probability distribution of the numeric representation of the data string, and b is the base of the logarithm. Common bases used in the logarithm include two, Euler’s number, and ten. The computing device generates entropy histograms for the string based on the string entropy. For example, the computing device may repeat process 300 on a multitude of strings that comprise a data set and determine information entropies for each of the strings. The computing device may then generate an entropy histogram that categorizes each of the strings by their entropy.

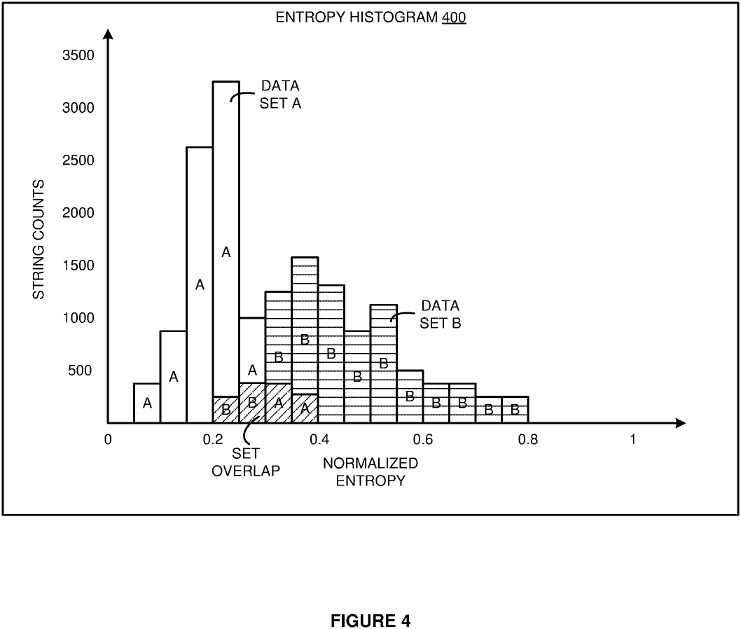

FIG. 4 illustrates entropy histogram 400. Entropy histogram 400 categorizes data strings into bins that sort the data string by normalized information entropy. Normalized information entropy may be computed by divided a calculated entropy by the number of tokens in the string. By normalizing the entropy, the entropy of different sized strings may be compared. In this example, entropy histogram 400 comprises two overlayed entropy histograms for data set A and data set B. Data set A comprises a first set of strings generated by a data pipeline while data set B comprises a second set of strings generated by the data pipeline. For example, data set A may comprise pipeline outputs for a first week while data set B may comprise pipeline outputs for a second week. The horizontal axis of the graph comprises a normalized entropy in an exemplary range of zero to one. One indicates a maximum normalized entropy while zero indicates a minimum entropy. The vertical axis of the graph indicates a string count in an exemplary range from zero to 3,500. The overlayed bars illustrate the change in entropy from one set of strings to another. In this example, the average string entropy for data set B is higher than the average string entropy for data set A. In some examples, the string counts for the entropy histograms may be normalized for different data sets to account for different data volumes. The bin size of entropy histogram 400 may be variable or uniform. For example, the bins of entropy histogram 400 may comprise ranges bounded by the values 0, 0.005, 0.01, 0.05, 0.1, 0.15, 0.2, 0.25, 0.3, 0.4, 0.5, 0.65, 0.8, and 1. However, it should be appreciated that the bins depicted in entropy 400 are exemplary and may differ in other examples.

In other examples, entropy histogram 400 may indicate data types, data labels, string character groups, string character types, or other data attributes aside from entropy.

In some examples, the constituent entropy histograms of entropy histogram 400 may be combined. However, when combining two distinct histograms, information loss occurs decreasing the utility of the entropy histogram. A computing device may track the number of times the histograms are combined. The computing device may avoid overlaying histograms that have been combined multiple times. For example, the computing device may avoid combining a histogram with another one after five combinations.

In some examples, the computing device compares the entropy between strings by overlaying the histograms as illustrated in FIG. 4. The overlapping region for data set A and data set B indicates the amount of similarity in string entropy between the two data sets. In some examples, a computing device may integrate over the overlayed region to quantify the amount of similarity between data set A and data set B. The computing device may utilize the amount of similarity to quantify the change in entropy between the two data sets. The computing device computes a mathematical distance between the entropies of set A and set B by determining the area created by overlapping rectangles in the overlapped region. The overlapping area indicates an intersection between the histograms of two different strings set. The size of the overlayed area correlates to the similarity between two different histograms. A larger intersecting area indicates a high degree of similarity while a small intersecting area indicates a low degree of similarity. The computing device may cumulatively sum the intersecting areas between the overlayed histograms. For example, the computing device may integrate over the overlayed histograms to cumulatively sum the intersecting area. Typically, cumulative summing will include the intersecting region of the overlayed histograms and a portion of the non-intersecting region of the overlayed histograms.

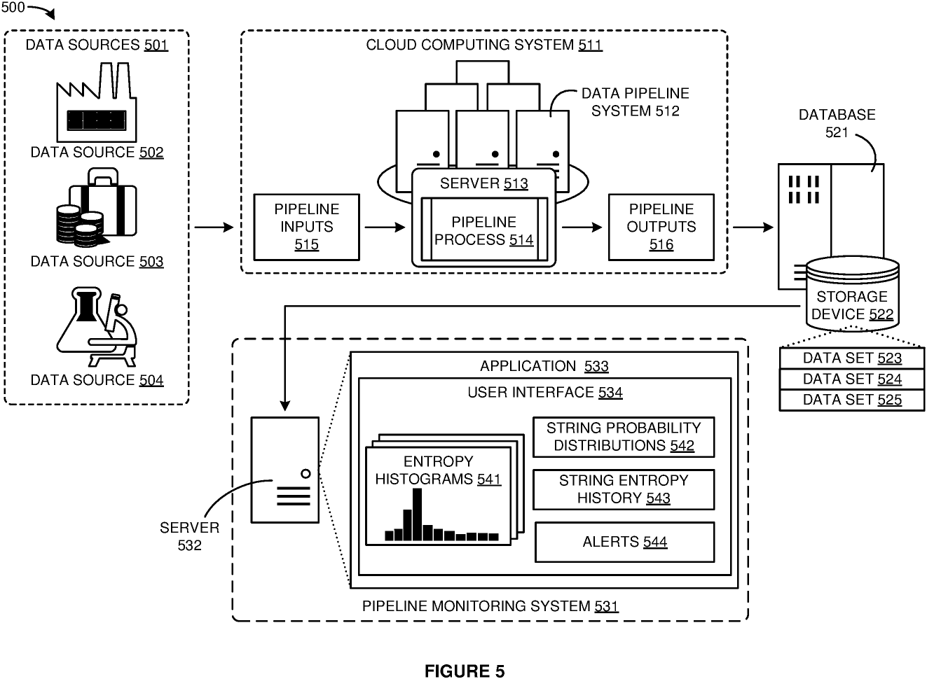

FIG. 5 illustrates data processing environment 500 to calculate and tack string entropy in data outputs generated by a data pipeline. Data processing environment 500 is an example of data processing environment 100, however data processing environment 100 may differ. Data processing environment 500 comprises data sources 501, cloud computing system 511, database 521, and pipeline monitoring system 531. Data sources 501 comprises data sources 502-504. Cloud computing system 511 comprises data pipeline system 512, server 513, pipeline process 514, pipeline inputs 515, and pipeline outputs 516. Database 521 comprises storage device 522 and data sets 523-525. Pipeline monitoring system 531 comprises server 532, application 533, user interface 534, entropy histograms 541, string probability distributions 542, string entropy history 543, and alerts 544. In other examples, data processing environment 500 may include fewer or additional components than those illustrated in FIG. 5. Likewise, the illustrated components of data processing environment 500 may include fewer or additional components, assets, or connections than shown. Each of data sources 501, cloud computing system 511, database 521, and/or pipeline monitoring system 531 may be representative of a single computing apparatus or multiple computing apparatuses.

Data sources 501 is representative of one or more computing devices configured to generate input data configured for ingestion by data pipeline system 512. Data sources 501 comprises individual data sources 502-504. Individual data sources 502-504 may produce industrial data, financial data, scientific data, machine learning data, and/or other types of input data for consumption by data pipeline system 512. In this example, at least a portion of the input data generated by data sources 501 comprise strings. Typically, the input data generated by data sources 501 comprise a form not-suitable for end user consumption (e.g., storage in database 521) and requires data processing by data pipeline system 512. It should be appreciated that the types of data sources that comprise data sources 501 and the input data generated by data sources 501 are not limited.

Cloud computing system 511 is representative of a data processing environment configured to receive and process input data from data sources 501. Cloud computing system 511 is an example of data pipeline system 111, however system 111 may differ. Cloud computing system 511 comprises data pipeline system 512, pipeline inputs 515, and pipeline outputs 516. Data pipeline system 512 is representative of one or more computing devices integrated into a network that communicates with data sources 501 and database 521, and pipeline monitoring system 531. Examples of data pipeline system 512 may include server computers and data storage devices deployed on-premises, in the cloud, in a hybrid cloud, or elsewhere, by service providers such as enterprises, organizations, individuals, and the like. Data pipeline system 512 may rely on the physical connections provided by one or more other network providers such as transit network providers, Internet backbone providers, and the like to communicate with data sources 501, database 521, and/or pipeline monitoring system 531. Data pipeline system 512 comprises server computer 513 which hosts pipeline process 514.

Server computer 513 comprises processors, bus circuitry, storage devices, software, and the like configured to host pipeline process 514. The processors may comprise CPUs, GPUs, ASICs, FPGAs, and the like. The storage devices comprise flash circuitry, RAM, HDDs, SSDs, NVMe SSDs, and the like. The storage devices store the software. The processors may retrieve and execute software stored on the storage devices to drive the operation of pipeline process 514. Server computer 513 hosts pipeline process 514. Pipeline process 514 comprises a series of processing algorithms configured to transform pipeline inputs 515 into pipeline outputs 516. The data processing algorithms may comprise one or more transform functions configured to operate on pipeline inputs 515. The transform functions may be executed by the processors of server 513 on pipeline inputs 515 and responsively generate pipeline outputs 516. Pipeline inputs 515 comprise data generated by data sources 501 and at least a portion of pipeline inputs comprise strings. Pipeline outputs 516 comprise data emitted by pipeline process 514. For example, pipeline process 514 may comprise a data cleaning process that transforms pipeline inputs 515 into pipeline outputs 516 suitable for storage in database 521. The cleaning process may comprise reformatting, redundancy removal, or some other type of operation to standardize pipeline inputs 515. It should be appreciated that pipeline process 514 is exemplary and the specific data processing operations implemented by pipeline process 514 are not limited.

In some examples, pipeline process 514 may comprise a machine learning model where pipeline inputs 515 represent machine learning inputs and pipeline outputs 516 represent machine learning outputs. The machine learning model may comprise one or more machine learning algorithms trained to implement a desired process. Some examples of machine learning algorithms include artificial neural networks, nearest neighbor methods, ensemble random forests, support vector machines, naive Bayes methods, linear regressions, or other types of machine learning algorithms that predict output data based on input data. In this example, pipeline inputs 515 may comprise feature vectors configured for ingestion by the one or more machine learning algorithms and pipeline outputs 516 may comprise machine learning decisions.

Database 521 comprises storage device 522 and is representative of a data target for pipeline process 514. Database 521 is an example of data target 121, however data target 121 may differ. Database 521 comprises processors, bus circuitry, storage devices (including storage device 522), software, and the like configured to store output data sets 523-525. The processors may comprise CPUs, GPUs, ASICs, and the like. The storage devices comprise flash drives, RAM, HDDs, SSDs, NVMe SSDs, and the like. The processors may retrieve and execute software stored upon the storage devices to drive the operation of database 521. Storage device 522 may comprise flash drives, RAM, HDDs, SSDs, NVMe SSDs, and the like configured to receive and stores pipeline outputs 516 generated from pipeline process 514 as data sets 523-525. Storage device 522 may implement a data structure that categorizes and organizes pipeline outputs 516 according to a data storage scheme. For example, output data sets 523-525 may be organized by data type, size, point of origin, and/or any other suitable data storage scheme. Database 521 may comprise user interface systems like displays, keyboards, touchscreens, and the like that allows a human operator to view the output data sets 523-525 stored upon storage device 522. The user interface systems may allow a human operator to review, select, and transfer ones of data sets 523-525 to pipeline monitoring system 531. At least a portion of data sets 523-525 comprise strings that were processed by pipeline process 514. Storage device 522 may transfer data sets 523-525 to calculate string entropy in sets 523-525.

Pipeline monitoring system 531 is representative of one or more computing devices integrated into a network configured to monitor the operation of data pipeline system 512. Pipeline monitoring system 531 is an example of monitoring system 131, however monitoring system 131 may differ. Pipeline monitoring system 531 comprises server computer 532. Server computer 532 comprises one or more computing devices configured to host application 533. Server 532 is communicatively coupled to database 521 to receive and ingest pipeline outputs 516. The one or more computing devices that comprise server 532 comprise processors, bus circuitry, storage devices, software, and the like. The processors may comprise CPUs, GPUs, ASICs, FPGAs, and the like. The storage devices comprise flash drives, RAM, HDDs, SSDs, NVMe SSDs, and the like. The storage devices store the software. The processors may retrieve and execute software stored on the storage devices to drive the operation of application 533. Server 532 is coupled to user interface 534. User interface 534 may include computers, displays, mobile devices, touchscreen devices, or some other type of computing device capable of performing the user interface functions described herein. A user may interact with application 533 via user interface 534 to generate, view, and interact with entropy histograms 541, string probability distributions 542, string entropy 543, and alerts 544.

Application 533 is representative of one or more pipeline monitoring applications user interface applications, operating systems, modules, and the like. Application 533 is an example of pipeline control module 134, however pipeline control module 134 may differ. Application 533 is configured to receive data sets 523-525 generated by data pipeline system 512 calculate string entropy for sets 523-525, and track changes in the string entropy over time.

User interface 534 provides a graphical representation of application 533. The graphical representation comprises a GUI. The graphical representation on user interface 534 includes entropy histograms 541, sting probability distributions 542, string entropy history 543, and alerts 544. In other examples, the graphical representation may include additional or different types of visual indicators relevant to the operation and status of data pipeline system 512. Entropy histograms 541 comprise a set of histograms that depict string entropy of the strings that comprise data sets 523-525. For example, one of entropy histograms 541 may categorize the entropy of strings that comprise data set 523 while another one of entropy histograms 541 may categorize the entropy of strings that comprise data set 524. Entropy histograms 541 comprise an example of entropy histogram 400 illustrated in FIG. 4, however histogram 400 may differ.

String probability distributions 542 comprise probability distributions for the tokens of the data strings that comprise sets 523-525. The distributions characterize the frequency token types that appear in the strings of sets 523-525. Each distribution may correspond to a string on an individual basis. Alternatively, the distributions may correspond to string types. Application 533 uses the probability distributions for the strings to calculate the entropy for the strings. For example, application 533 may execute a function that uses Equation (1) to calculate the string entropy. String entropy history 543 comprises one or more metrics that track the entropy of strings generated by pipeline process 514 over time. For example, entropy histograms 541 may overlay chronological ones of entropy histograms 541 and calculate a change in entropy over time based on the overlay. Alerts 544 comprises one or more notifications that indicate when an undesired entropy change occurs. For example, application 533 may overlay entropy histograms 541 and identify an undesired change in entropy and responsively present alerts 544 on user interface 534.

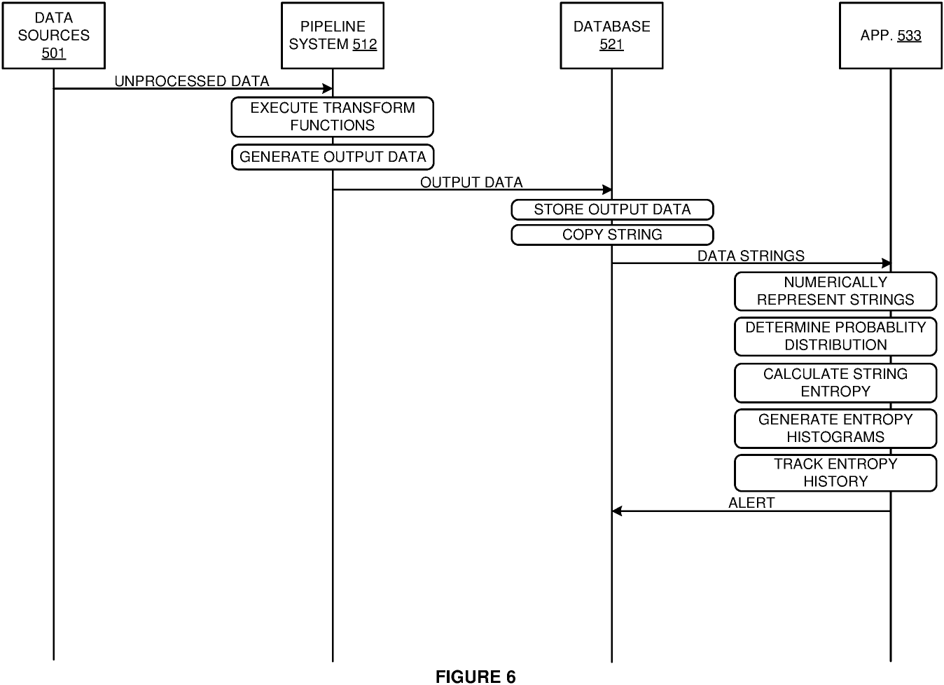

FIG. 6 illustrates an exemplary operation of data processing environment 500 to calculate and track string entropy for strings in data outputs generated by a data pipeline. The operation depicted by FIG. 6 comprises an example of process 200 illustrated in FIG. 2 and process 300 illustrated in FIG. 3, however process 200 and process 300 may differ. In other examples, the structure and operation of data processing environment 500 may be different.

In operation, data sources 501 transfer unprocessed data to data pipeline 512. For example, data sources 501 may generate user subscription data comprising strings and transfer the user subscription data to pipeline system 512 for processing. Data pipeline system 512 receives the unprocessed data as pipeline inputs 515. Data pipeline system 512 ingests pipeline inputs 515 and implements pipeline process 514. Pipeline process 514 cleans, transforms, applies a schema, or otherwise processes pipeline inputs 515 into a consumable form to generate pipeline outputs 516. Data pipeline system 512 transfers pipeline outputs 516 to database 521. Database 521 receives pipeline outputs 516 as output data and stores the output data in storage device 522 as data sets 523-525. Database 521 calls application 533 hosted by server computer 532 to ingest data sets 523-525 generated by data pipeline system 512 to calculate string entropy for sets 523-525.

Application 533 accepts the call from database 521 and receives data set 523. Application 533 extracts a string from data set 523. Application 533 analyzes the string to identify each of the tokens in the string. For example, application 533 may comprise a data parsing function that breaks the string down into its constituent tokens. Application 533 stems the tokens to remove affixes like prefixes, suffixes, gerunds, plurals, and the like from the tokens. In doing so, application 533 may reduce the amount of token types. For example, without stemming application 533 may classify the tokens RUN and RUNS as different token types, but with stemming, application 533 may remove the plural suffix from RUNS and classify the tokens as the same type.

Application 533 identifies all of the token types present in the string and assigns a number to each of the token types to numerically represent the string. Application 533 constructs a numeric string of the numbers that corresponds to the token order of the string. Application 533 determines a probability distribution for the string based on the numeric representation. For example, application 533 may plot the numbers of the numeric string and compare numbers to a geometric probability distribution and responsively determine that the numeric representation is geometrically distributed. However, it should be appreciated that the type of probability distribution for the string is not limited. Application 533 stores the probability distribution for the string as string probability distribution 542.

Application 533 calculates the information entropy for the string based on the probability distribution of the numeric representation of the string. For example, application 533 may execute an algorithmic process like Equation (1) that takes the string probability distribution as an input and determines string entropy as an output. Application 533 repeats the above process for each of the strings that comprise data set 523. Application 533 generates an entropy histogram for data set 523 that categorizes the strings of data set 523 by entropy.

Application 533 repeats the above string entropy calculation process for data sets 524 and 525. Application 533 generates entropy histograms for data sets 524 and 525 that, along with the entropy histogram for data set 523, form entropy histograms 541. Application 533 displays entropy histograms 541 on user interface 534. Application 533 overlays the entropy histograms for data sets 523-525 to track how entropy changes over time. For example, data sets 523-525 may comprise data generated over three consecutive weeks of operation by pipeline system 512. Application 533 measures the amount of overlap between the entropy histograms to determine a change in entropy. For example, application 533 may determine a statistical distance between two different entropy histograms. The distance may comprise a geometric distance, a Hamming distance, Jaccard distance, or some other type of statistical metric to quantify a mathematic difference between histograms. Application 533 determines the change in entropy between data sets 523-525 to generate string entropy history 543 and to indicate if string entropy is increasing, decreasing, or remaining constant. Generally, when a large increase in string entropy is observed, a problem may have occurred in pipeline process 514 and/or pipeline inputs 515.

When application 533 detects an unusual increase in string entropy, application 533 generates alerts 544. For example, application 533 may apply an entropy threshold to observed entropy increases to identify when an undesired entropy increase occurs. The entropy threshold may be user defined and depend on the type of data that comprise data sets 523-525. For example, the entropy threshold may be stricter when data sets 523-525 comprise sensitive data like medical records than when data sets 523-525 comprise less sensitive data like sales data. Alerts 544 indicates the one of data sets 523-525 that exceeded the entropy threshold. Alert 544 may include additional information that identifies the date of operation the change occurred and how severe the change was (e.g., observed entropy). Application 533 transfers the alert to pipeline system database 521 to notify database operators to respond to the observed entropy increase change in data sets 523-525. When application 533 does not detect an unusual increase in string entropy, application 533 does not generate and transfer alerts 544.

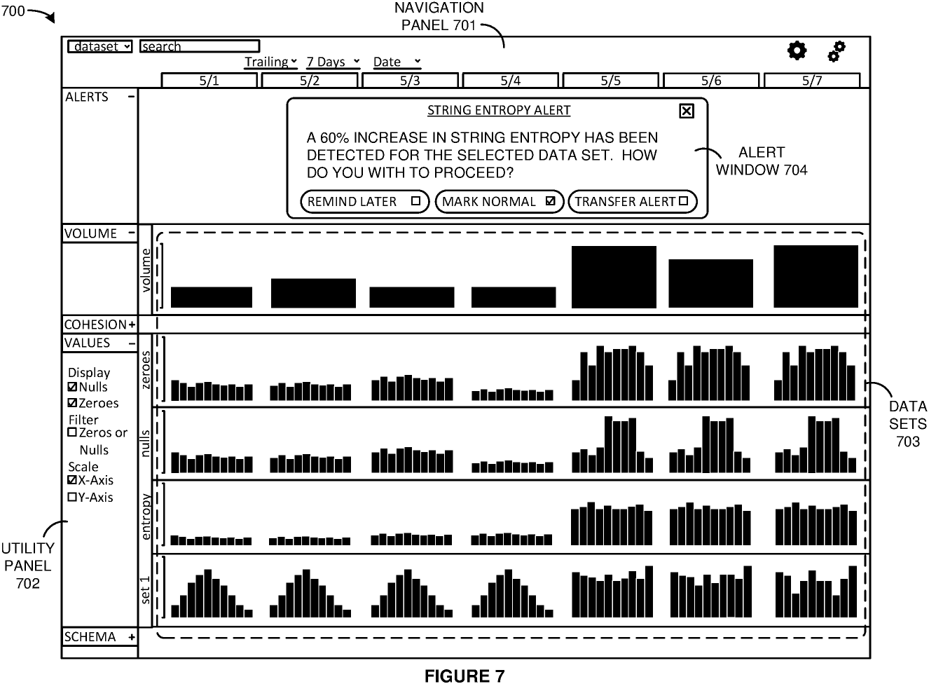

FIG. 7 illustrates user interface 700 to calculate and track information entropy in strings output by a data pipeline. User interface 700 comprises an example of user interface 133 and user interface 534, however user interface 133 and user interface 534 may differ. User interface 700 comprises a pipeline monitoring application presented on a display screen which is representative of any user interface for calculating and tracking string entropy in data associated with a data pipeline. User interface 700 comprises a GUI configured to allow a user to view operational metrics for a data pipeline like data volume and string entropy and to receive alerts regarding detected entropy changes. The GUI provides visualizations for how data set volume, data set values, data set entropy, data set zero values, and data set null values change over time. In other examples, the GUI of user interface 700 may include additional elements not illustrated in FIG. 7 to determine and track information entropy.

User interface 700 includes navigation panel 701. Navigation panel 701 comprises tabs like “dataset” and “search” that allows a user to find and import data sets into user interface 700. For example, a user may interact with the “dataset” tab to import a data set comprising strings from a data storage system that receives the outputs of the pipeline. Navigation panel 701 also includes date range options to select data sets a data set from a period of time. In this example, a user has selected to view a data set over a week ranging from May 1^{st} to May 7^{th} labeled as 5/1-5/7 in user interface 700. In other examples, a user may select a different date range and/or a different number of days.

User interface 700 includes utility panel 702. Utility panel 702 comprises tabs labeled “ALERTS”, “VOLUME”, “COHESION”, “VALUES”, and “SCHEMA”. In other examples, utility panel 702 may comprise different tabs than illustrated in FIG. 7. When a user selects one of the tabs, the tab expands to reveal its contents. In this example, a user has opened the “VALUES” tab, the “VOLUME” tab, and the “ALERTS” tab. The “VALUES” tab and the “VOLUME” tab comprises data sets 703. The “VALUES” tab also includes display options to modify the view of data sets 703. The display options include toggles labeled “Nulls”, “Zeroes”, “Zeroes or Nulls”, “X-Axis”, and “Y-Axis”. In other examples, the display options may differ. The “ALERTS” tab comprises alert window 704.

User interface 700 includes data sets 703. Data sets 703 comprises histogram visualizations of data sets imported into user interface 700. In this example, data sets 703 include “volume”, “zeroes”, “nulls”, “entropy”, and “set 1”. Each set of data sets 703 corresponds to the date selected by a user in navigation panel 701. For example, the “zeroes” data set of data sets 703 is presented as a row with each portion of the set corresponding to the dates presented in navigation panel 701. Data sets 703 allows a user to view the shape and/or other attributes of the imported data sets. The “zeroes” sets of data sets 703 comprise histograms that characterize the number of zero values for the data fields that comprise outputs of a data pipeline. The “nulls” sets of data sets 703 comprise histograms that characterize the number of null fields for the data sets that comprise outputs of a data pipeline. The “entropy” sets of data sets 703 comprise histograms that characterize the information entropy in strings for the outputs of a data pipeline. The “volume” sets of data sets 703 indicates the data volume output by the data pipeline. The “set 1” sets of data sets 703 comprises histograms that characterize the value distributions for the data fields that comprise outputs of a data pipeline. In other examples, data sets 703 may comprise different types of data sets than those illustrated in FIG. 7.

User interface 700 includes alert window 704. Alert window 704 comprises a user selectable option and indicates that a 60% increase in string entropy has been detected. For example, the data monitoring application represented by user interface 700 may track string entropy over time and present alert window 704 on user interface 700 when an anomalous increase in string entropy is observed. Alert window 704 comprises a set of user selectable options to respond to the string entropy alert. The user selectable options comprise options to transfer an alert, mark as normal, or to remind later. In other examples, alert window 704 may comprise different user selectable options. In this example, a user has selected the option to mark the increase in entropy as normal. For example, the structure of the inputs to a data pipeline may have changed and a corresponding increase in string entropy may have been expected. In other examples, a user may select the option to transfer an alert or to remind later. In should be appreciated that alert window 704 is exemplary and may differ in other examples.

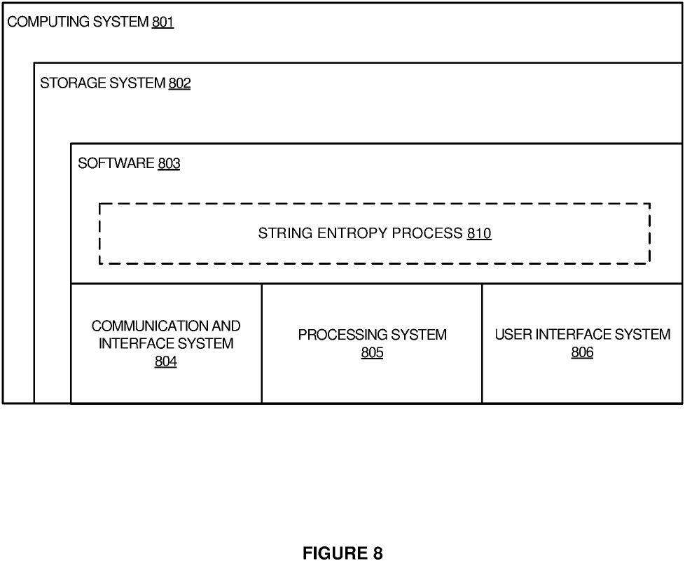

FIG. 8 illustrates computing device 801 which is representative of any system or collection of systems in which the various processes, programs, services, and scenarios disclosed herein for calculating and tracking string entropy for outputs of a data pipeline within data processing environments may be implemented. For example, computing device 801 may be representative of data pipeline system 111, data target 121, computing device 132, user interface 133, cloud computing system 511, database 521, server 532, and/or user interface 700. Examples of computing system 801 include, but are not limited to, server computers, routers, web servers, cloud computing platforms, and data center equipment, as well as any other type of physical or virtual server machine, physical or virtual router, container, and any variation or combination thereof.

Computing system 801 may be implemented as a single apparatus, system, or device or may be implemented in a distributed manner as multiple apparatuses, systems, or devices. Computing system 801 includes, but is not limited to, storage system 802, software 803, communication and interface system 804, processing system 805, and user interface system 806. Processing system 805 is operatively coupled with storage system 802, communication interface system 804, and user interface system 806.

Processing system 805 loads and executes software 803 from storage system 802. Software 803 includes and implements string entropy process 810, which is representative of the processes to calculate and track string entropy in data pipeline outputs discussed with respect to the preceding Figures. For example, string entropy process 810 may be representative of process 200 illustrated in FIG. 2, process 300 illustrated in FIG. 3, and/or the exemplary operation of environment 500 illustrated in FIG. 6. When executed by processing system 805, software 803 directs processing system 805 to operate as described herein for at least the various processes, operational scenarios, and sequences discussed in the foregoing implementations. Computing system 801 may optionally include additional devices, features, or functionality not discussed here for purposes of brevity.

Processing system 805 may comprise a micro-processor and other circuitry that retrieves and executes software 803 from storage system 802. Processing system 805 may be implemented within a single processing device but may also be distributed across multiple processing devices or sub-systems that cooperate in executing program instructions. Examples of processing system 805 include general purpose central processing units, graphical processing units, application specific processors, and logic devices, as well as any other type of processing device, combinations, or variations thereof.

Storage system 802 may comprise any computer readable storage media that is readable by processing system 805 and capable of storing software 803. Storage system 802 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 802 may also include computer readable communication media over which at least some of software 803 may be communicated internally or externally. Storage system 802 may be implemented as a single storage device but may also be implemented across multiple storage devices or sub-systems co-located or distributed relative to each other. Storage system 802 may comprise additional elements, such as a controller, capable of communicating with processing system 805 or possibly other systems.

Software 803 (string entropy process 810) may be implemented in program instructions and among other functions may, when executed by processing system 805, direct processing system 805 to operate as described with respect to the various operational scenarios, sequences, and processes illustrated herein. For example, software 803 may include program instructions for comparing string entropy histograms for different data sets to track changes in entropy as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 803 may include additional processes, programs, or components, such as operating system software, virtualization software, or other application software. Software 803 may also comprise firmware or some other form of machine-readable processing instructions executable by processing system 805.

In general, software 803 may, when loaded into processing system 805 and executed, transform a suitable apparatus, system, or device (of which computing system 801 is representative) overall from a general-purpose computing system into a special-purpose computing system customized to determine and track string entropy as described herein. Indeed, encoding software 803 on storage system 802 may transform the physical structure of storage system 802. The specific transformation of the physical structure may depend on various factors in different implementations of this description. Examples of such factors may include, but are not limited to, the technology used to implement the storage media of storage system 802 and whether the computer-storage media are characterized as primary or secondary storage, as well as other factors.

For example, if the computer readable storage media are implemented as semiconductor-based memory, software 803 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 804 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples provided herein are described in the context of computing devices to calculate and track information entropy in data strings, it should be understood that the systems and methods described herein are not limited to such embodiments and may apply to a variety of other extension implementation environments and their associated systems. As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A data pipeline monitoring system to determine entropy in strings generated by a data pipeline, the data pipeline monitoring system comprising:
data monitoring circuitry configured to monitor the data pipeline wherein the data pipeline ingests an input data set, processes the input data set, responsively generates a data string that comprises character groups, and transfers the data string to the data monitoring circuitry;
the data monitoring circuitry configured to receive the data string, identify character groups in the data string, identify group types for the character groups, numerically represent the character groups based on the group types, determine a probability distribution for the numeric representations, calculate entropy for the data string based on probability distribution, and generate an entropy histogram based on the entropy; and
the data monitoring circuitry configured to compare the entropy histogram of the data string to another entropy histogram for another data string, determine a change in entropy between the entropy histogram and the other histogram, and report the change in entropy.

2. The data pipeline monitoring system of claim 1 wherein the data monitoring circuitry is configured to identify the character groups, identify the group types, and numerically represent the character groups comprises the data monitoring circuitry configured to identify a duplicate group comprising a set of identical ones of the character groups and assign one of the numeric representations to the duplicate group.

3. The data pipeline monitoring system of claim 1 further comprising the data monitoring circuitry configured to stem the character groups to remove affixes from the character groups.

4. The data pipeline monitoring system of claim 1 wherein the data monitoring circuitry is configured to identify group types for the character groups comprises the data monitoring circuitry configured to identify similarities between different ones of the character groups and identify the group types of the different ones of the character groups based on the similarities.

5. The data pipeline monitoring system of claim 1 further comprising:
the data monitoring circuitry configured to determine a normalized entropy based on the calculated entropy for the data string and an amount of the numeric representations that represent the data string; and wherein:
the data monitoring circuitry is configured to generate the entropy histogram based on the entropy comprises the data monitoring circuitry configured to generate the entropy histogram based on the normalized entropy.

6. The data pipeline monitoring system of claim 1 wherein the data monitoring circuitry is configured to compare the entropy histogram to the other entropy histogram comprises the data monitoring circuitry configured to overlay the entropy histogram on the other histogram, measure an amount of overlap between the entropy histogram and the other histogram, and determine the change in entropy based on the amount of overlap.

7. The data pipeline monitoring system of claim 1 wherein the data monitoring circuitry is configured to compare the entropy histogram to the other entropy histogram comprises the data monitoring circuitry configured to determine a statistical distance between the entropy histogram and the other entropy histogram and determine the change in entropy based on the statistical distance.

8. A method of operating a data processing system to determine entropy in strings generated by a data pipeline, the method comprising:
data monitoring circuitry monitoring the data pipeline wherein the data pipeline ingests an input data set, processes the input data set, responsively generates a data string that comprises character groups, and transfers the data string to the data monitoring circuitry;
the data monitoring circuitry receiving the data string, identifying character groups in the data string, identifying group types for the character groups, numerically representing the character groups based on the group types, determining a probability distribution for the numeric representations, calculating entropy for the data string based on probability distribution, and generating an entropy histogram based on the entropy; and
the data monitoring circuitry comparing the entropy histogram of the data string to another entropy histogram for another data string, determining a change in entropy between the entropy histogram and the other histogram, and reporting the change in entropy.

9. The method of claim 8 wherein the data monitoring circuitry identifying the character groups, identifying the group types, and numerically representing comprises the data monitoring circuitry identifying a duplicate group comprising a set of identical ones of the character groups and assigning one of the numeric representations to the duplicate group.

10. The method of claim 8 further comprising the data monitoring circuitry stemming the character groups to remove affixes from the character groups.

11. The method of claim 8 wherein the data monitoring circuitry identifying group types for the character groups comprises the data monitoring circuitry identifying similarities between different ones of the character groups and identifying the group types of the different ones of the character groups based on the similarities.

12. The method of claim 8 further comprising:
the data monitoring circuitry determining a normalized entropy based on the calculated entropy for the data string and an amount of the numeric representations that represent the data string; and wherein:
the data monitoring circuitry generating the entropy histogram based on the entropy comprises the data monitoring circuitry generating the entropy histogram based on the normalized entropy.

13. The method of claim 8 wherein the data monitoring circuitry comparing the entropy histogram to the other entropy histogram comprises the data monitoring circuitry overlaying the entropy histogram on the other histogram, measuring an amount of overlap between the entropy histogram and the other histogram, and determining the change in entropy based on the amount of overlap.

14. The method of claim 8 wherein the data monitoring circuitry comparing the entropy histogram to the other entropy histogram comprises the data monitoring circuitry determining a statistical distance between the entropy histogram and the other entropy histogram and determining the change in entropy based on the statistical distance.

15. A non-transitory computer-readable medium storing instructions to determine entropy in strings generated by a data pipeline, wherein the instructions, in response to execution by one or more processors, cause the one or more processors to drive a system to perform operations comprising:
monitoring the data pipeline wherein the data pipeline ingests an input data set, processes the input data set, responsively generates a data string that comprises character groups, and transfers the data string;
receiving the data string;
identifying character groups in the data string;
identifying group types for the character groups;
numerically representing to the character groups based on the group type;
determining a probability distribution for the numeric representations;
calculating entropy for the data string based on probability distribution;
generating an entropy histogram based on the entropy;
comparing the entropy histogram of the data string to another entropy histogram for another data string;
determining a change in entropy between the entropy histogram and the other histogram;
and reporting the change in entropy.

16. The non-transitory computer-readable medium of claim 15, the operations further comprising:
stemming the character groups to remove affixes from the character groups;
identifying a duplicate group comprising a set of identical ones of the character groups; and
assigning one of the numeric representations to the duplicate group.

17. The non-transitory computer-readable medium of claim 15, the operations further comprising:
identifying similarities between different ones of the character groups; and
identifying the group types of the different ones of the character groups based on the similarities.

18. The non-transitory computer-readable medium of claim 15, the operations further comprising:
determining a normalized entropy based on the calculated entropy for the data string and an amount of the numeric representations that represent the data string; and
generating the entropy histogram based on the normalized entropy.

19. The non-transitory computer-readable medium of claim 15, the operations further comprising:
overlaying the entropy histogram on the other histogram;
measuring an amount of overlap between the entropy histogram and the other histogram; and
determining the change in entropy based on the amount of overlap.

20. The non-transitory computer-readable medium of claim 15, the operations further comprising:
determining a statistical distance between the entropy histogram and the other entropy histogram; and
determining the change in entropy based on the statistical distance.
